(19) United States
(12) Patent Application Publication
(10) Pub. No.: US 2005/0116075 A1
(43) Pub. Date: Jun. 2, 2005

(54) Crushing device

(76) Inventors: Donat Bosch, Balzers Liechtenstein (LI); Philippe Bachmann, Fiez (CH)

Correspondence Address: OSTROLENK FABER GERB & SOFFEN, 1180 AVENUE OF THE AMERICAS, NEW YORK, NY, 100368403, US

(21) Appl. No.: 10/509,135

(22) PCT Filed: Mar. 24, 2003
(86) PCT No.: PCT/EP03/03038

(30) Foreign Application Priority Data
Mar. 25, 2002 (CH) 2002/0520-02

(51) Int. Cl. B02C 18/16

(52) U.S. Cl. 241/236

(57) ABSTRACT

The invention relates to a crushing device, for example for crushing products associated with the disposal, processing and recycling of refuse and valuable materials. According to the invention, the device consists of at least one rotor (1), on the periphery of which hooks are mounted (3) and at least one stator (4, 7), whereby the latter (4, 7) can be offset in the direction of the rotor axis (2) and/or rotated about its stator axis (5), once its locked position has been released. Crushing elements (6) are mounted on the stator (4), a lateral edge (10a) being aligned transversally to the direction of material flow and co-operating with the hooks (3) during the crushing process. At least one hook (3) rotates between two respective crushing elements (6), the rotational plane of said hook being located in a substantially eccentric area in relation to the interval between two crushing elements (6). By rotating the stator (4) through 90°, the edge (10a) can be replaced by the following edge (10b) in the peripheral direction, thus considerably prolonging the service life of the stator (4).

### FIELD OF THE INVENTION

The invention relates to a crushing device for crushing products of all types, consisting of at least one rotor, on the periphery of which hooks are mounted, and at least one stator.

### BACKGROUND OF THE INVENTION

Such machines are used for crushing products of all types, in particular in the disposal, processing and recycling of wastes and useful materials.

The material introduced into the crushing device is contacted by the hooks of at least one rotor, pulled downwards in the direction of material flow and, by cooperation with a stator, torn, shredded, crushed, cut and/or squashed, depending on the type of crushing device.

Crushing machines can be hydraulically driven and are provided with the known devices for automatic change of direction of rotation to clockwise or counterclockwise operation.

The choice of suitable crushing machines with regard to drive, size, number of and equipment with rotors and stators is effected according to the required
throughput,
particle size of the crushed material, and
life.

A problem of such crushing devices is the wear of the hooks and of the stator, depending on the material to be crushed. Because of the wear, the spaces between the crushing elements increase, with the result that the efficiency of the crushing decreases due to the wear. The replacement of worn elements is very expensive and time-consuming.

WO 00/44499 discloses a crushing device in which U-shaped disc segments are inverted, for protection against wear, over the crushing elements of the rotor which are in the form of hooks.

The Laid-Open Application JP 2001-149806A discloses a two-axis breaking machine—in particular for industrial wastes—in which the crushing is effected by breaking blades which are arranged on two shafts and have a shears-like action. Secondary additional crushing is effected by downstream, stationary blades whose distance from the shafts is adjustable in order to be able to compensate wear and adjust the particle size. The empty space between the individual breaking blades is small, and the actual crushing therefore takes place mainly through the interaction of the rotors—in particular via the back edges of the breaking blades which are difficult to process or replace—and said rotors are therefore exposed to considerable wear. Smaller parts, which, owing to their small size, would not have to be crushed, are likewise contacted and cause additional wear.

DE 106 19 411 describes a processing machine for minerals, in which the crushing is effected by two toothed rolls, the teeth of which are arranged at a radial distance from one another. The final particles are forced by the teeth of the two toothed rolls additionally through a comb-like, flexibly mounted die and are thus further crushed. In the die, cutting, breaking and tearing take place at three edges of the teeth. The spaces between the teeth and the die have only a small amount of empty spaces, so that, in this machine too, small parts not necessarily to be crushed are contacted and cause wear. The teeth of the toothed rolls, which are difficult to repair, are subject to particular wear by the first crushing process and the subsequent forcing through the dies.

### SUMMARY OF THE INVENTION

It is the object of the invention to provide a crushing device in which the wear of the crushing elements is both small and can be compensated without dismantling and the associated down times. This object is achieved for the first time in a surprising manner, inter alia, by the features of Patent Claim 1. Alternative or advantageous further developments of the invention are described in the dependent Claims.

In achieving the object, the invention starts from the basic concept that, on the one hand, a special arrangement of the hooks on the rotor and of the crushing elements on the stator leads to little wear and, on the other hand, the spaces between the hook of the rotor and the stator which are enlarged by the wear can be compensated if, on the one hand, the stator is offset in the direction of the rotor axis and/or in the direction of the rotor axis [sic] and, on the other hand, the stator is rotated through a certain angle so that a worn side of the stator is replaced by an unused side of the stator.

The invention has the advantage that, through the above-mentioned measures, the life of the crushing device according to the invention is increased several times over without dismantling of the crushing elements. Owing to the adjustability of the position of the stator relative to the rotor, throughput and particle size can additionally be regulated.

### BRIEF DESCRIPTION OF THE DRAWINGS

FIG. 1 shows a crushing device in cross-section, having two rotors and a stator.

FIG. 2 shows the crushing device from FIG. 1 in plan view.

FIG. 3a shows an adjustable lock of the stator in a “lower” position.

FIG. 3b shows an adjustable lock of the stator in an “upper” position.

FIG. 4 shows a hydraulic lock of the stator.

FIG. 4a shows, in a detailed view, the hydraulic lock of the stator in a “lower” position.

FIG. 4b shows, in a detailed view, the hydraulic lock of the stator in an “upper” position.

FIGS. 5a and 5b show a crushing device having four rotors and three stators.

FIGS. 6a and 6b show a crushing device having a rotor and laterally arranged stators.

### DETAILED DESCRIPTION OF THE INVENTION

The invention is to be explained in more detail below.

In the comminuting device according to the invention, the material fed in is contacted by the hooks of at least one rotor, pulled downwards in the direction of material flow and torn, shredded, broken, cut and/or squashed against a stator. The actual crushing is effected substantially by the cooperation between hook and stator, since the distances between the rotors and the spaces between the hooks are so large that only a slight interaction takes place between the hooks of the rotors. Since it is therefore the stator which in particular is fully exposed to the material flow of the material to be crushed, it is mainly the stator material which is worn. According to the invention, moreover, the position of the stator can be offset in the direction of the rotor axis,—i.e. the distance from the rotor axis can be reduced—and/or can be rotated about the stator axis. For changing the position, the—optionally hydraulic and/or mechanical—locking of the stator is released. In a further embodiment of the invention, after release of the locking, the stator can additionally be displaced axially, i.e. in the direction of the rotor axis.

The displacement of the position of the stator makes it possible to compensate the wear of the elements involved in the crushing process—in particular of the hooks and crushing elements of the stator—since the gap between the hooks of the rotor and the crushing elements of the stator, which is widened by the wear, can be reduced by simply displacing the stator. Furthermore, the adjustment of the position of the stator provides an additional possibility for regulating the throughput and the particle size.

The adjustment mechanism for displacing the position of the stator can be formed, for example, mechanically by screwing to a manually operated hydraulic cylinder or to an automated—in particular hydraulic—system.

In the direction of flow of the material to be crushed, the stator is arranged downstream of the rotor. By means of the special arrangement, according to the invention, of the hooks on the rotor and of the stator, the actual crushing takes place substantially through the cooperation between hook and stator, since the distances between the rotor axes and the spaces between the hooks are so large that only little interaction takes place between the hooks of the rotors.

The stator can be mounted, for example, below the rotor, approximately parallel to the rotor shaft, and can be fastened to the crossbeams of the frame of the crushing device. If a plurality of rotor shafts are mounted, the stator is positioned between the rotor shafts—preferably displaced in a downward direction. If required, the stator may additionally be protected by wearing plates.

In addition, the stator can also be arranged on the frame, to the side of the rotor, optionally between two hooks, and/or longitudinally, optionally parallel, to the rotor axis and perpendicular to the hook. Those stators which in particular perform the function of a scraper and prevent emergence of the crushed material in the direction opposite to the direction of introduction can also be formed so as to be displaceable in their position. By means of these stators, the space between the frame and the rotors is reduced.

At least one fixed crushing element composed of one or more parts is fastened to the stator. This element can be mounted on the stator so as to be replaceable and can optionally be protected by wearing plates or welded-on parts.

The number and arrangement of the crushing elements on the stator is chosen according to the function and the arrangement of the hooks on the rotors and of the desired crushing performance with regard to the throughput and the particle size.

The particular arrangement of the stator with the crushing elements in the spaces formed from the rotors and hooks enables already small-particled material to fall through, whereas large pieces of material cannot fall through and are thus crushed.

Through the cooperation of rotor and stator, throughput and particle size are regulated and, inter alia, the following effects are achieved:
cleaning of the rotor and the hooks thereof,
additional crushing of the material between rotor and stator, and
more uniform particle size distribution through the improved sieve effect.

Since the distances between the rotor axes and the spaces between the hooks are so large that only little interaction takes place between the hooks of the rotors and hence the actual crushing occurs at the stator, mainly the front edges of the hooks, in particular in each case a single lateral edge and possibly a front edge on the front of a hook, and the breaking edges of the stator, are exposed to wear, whereas the rear edges of the hooks, which edges are difficult to repair, experience only slight wear. Small parts which need not be crushed can fall through and cause no additional wear. Owing to the larger spaces, the machine is furthermore more economical and lighter since it is possible to save material.

The crushing elements on the stator are plate-like and may have a polygonal or disc-shaped cross-section. The crushing elements preferably have at least three lateral edges, one of which is oriented substantially transversely to the direction of flow of the material to be crushed and cooperates with the hook. In a particular embodiment of the invention, the crushing element has four lateral edges and a substantially orthogonal shape. Owing to this design, in each case only one edge and one side, or a part of the edges and sides running round the crushing element, are involved in the crushing and are effected by the flow of the material to be crushed and the associated wear. By rotating the stator about the stator axis, the edge exposed to wear can be displaced and replaced by an unworn edge which follows in the circumferential direction, opposite to the direction of rotation. By means of this measure according to the invention, the life of the stator is increased several times over.

The hydraulic system for fixing or locking and/or displacing the stator can also be used for protection from overloading. If required, the hydraulic fixing means for displacement of the stator in the event of overloading can be adjusted so that, when a specified load is exceeded, the lock is released and the stator then moves either axially and/or transversely to its axis. This is a substantial simplification compared with the complicated systems known from the prior art and intended for overload protection, in which the stators are, for example, swivelled away in the event of overloading. Optionally, the hydraulic fixing can engage again as soon as the overload is terminated.

The individual hooks can be mounted in a replaceable manner on the rotor. In the context of the invention, “hooks” are understood as meaning the formations of crushing elements on rotors, which are known from the prior art and are suitable for contacting material to be crushed and crushing said material through at least one cutting, tearing or breaking effect. This term is intended to include, for example, rotor discs in the form of a toothed wheel.

Depending on the requirements with regard to the resistance to wear and material resistance, the hooks can be equipped with protective elements. Such protective elements are described, for example, in WO 00/44499. For example, rotor disc segments having a U-shape—optionally with extensions for shaft protection—can be inverted over the hooks.

In machines having a plurality of rotors, the rotor shafts are arranged approximately parallel to one another. The opposite hooks on the rotors substantially parallel to one another are preferably arranged offset relative to one another, the distance between the rotor shaft being chosen so that the areas of action of the hooks opposite to one another overlap only slightly and intermesh to a small extent.

In a further embodiment of the invention, the position of the rotor is also displaceable—optionally hydraulically. For adjusting the rotor, it is possible to take the same measures as for adjusting the stator.

Below, the figures are described in detail with examples for embodiments of the invention.

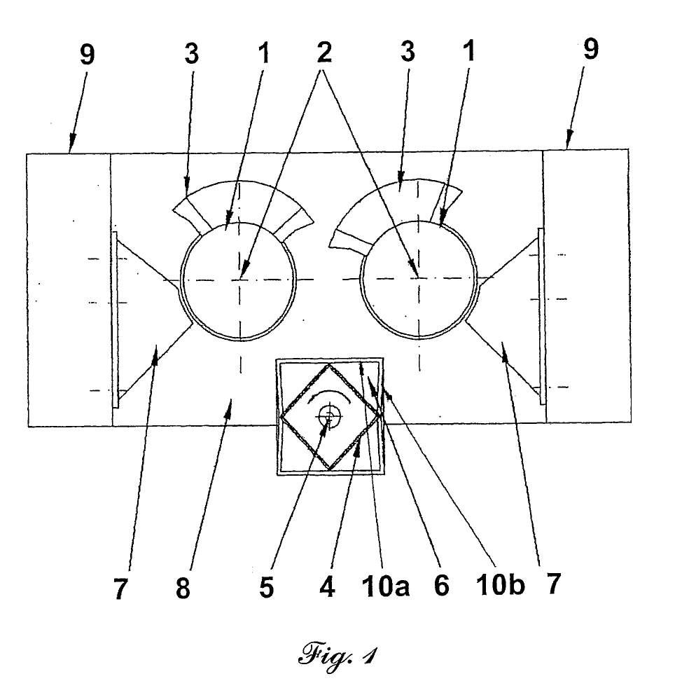

FIG. 1 shows, in cross-section, a crushing device according to the invention, comprising a frame which is formed from crossbeams 8 and longitudinal beams 9. Two rotors 1 in the form of shafts are arranged, substantially parallel to one another, inside the frame. Hooks 3 are mounted as crushing elements on the rotors 1. The distance between the rotors 1 is chosen so that the areas of action of the hooks 3 intermesh only slightly. For crushing, the material is introduced into the device above the rotors 1 and contacted by the hooks 3 and can optionally be slightly crushed beforehand thereby. A bar-like stator 4, at which the actual crushing process takes place, is arranged after the hooks 3 in the direction of material flow, below and between the two rotors 1. The stator 4 which is fixed to prevent rotation is rotatable about the stator axis 5. Crushing elements 6 having an orthogonal cross-section are fastened to the stator 4. The crushing elements 6 are, if required, individually replaceable. A lateral edge 10a of the crushing element 6 is oriented transversely to the direction of flow of the material to be crushed. Once the life of the edge 10a has been exceeded, the lock of the stator 4 can be released and the stator can be rotated through 90°, with the result that the still unworn edge 10b which follows in the circumferential direction, opposite to the direction of rotation, is moved so that it is transverse to the direction of material flow. After further fixing or locking of the stator 4, the crushing can be continued. In addition, lateral stators 7 are mounted on the two longitudinal beams 9, between the frame and the rotors 1, perpendicular to the rotor axis 2, and are optionally formed so as to be adjustable in height relative to the rotor axis 2.

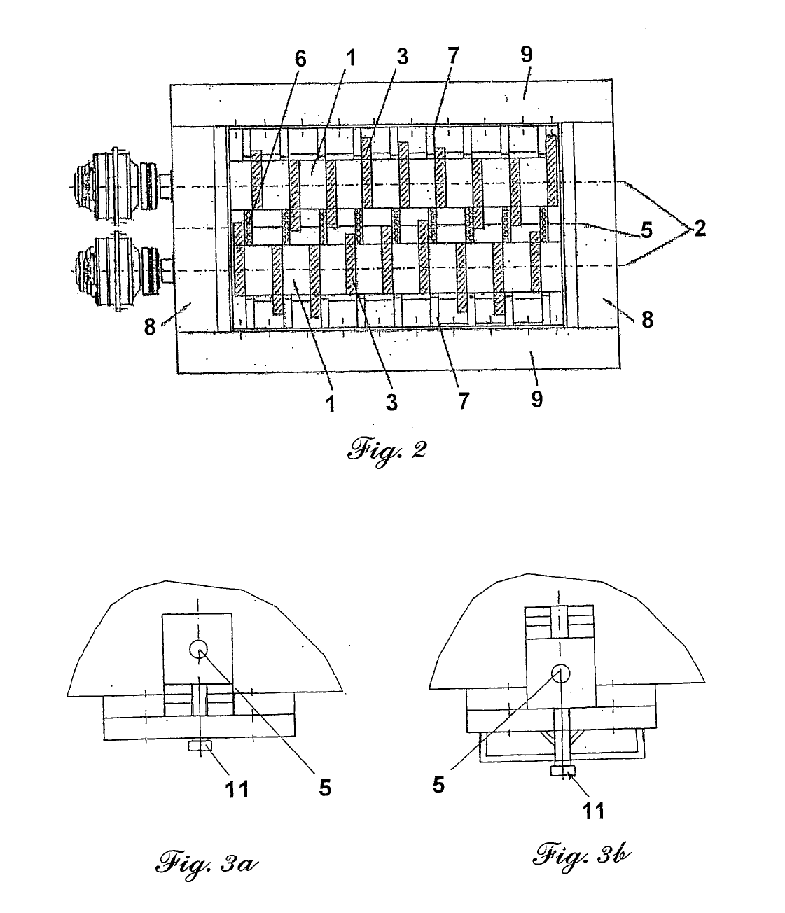

FIG. 2 shows the crushing device from FIG. 1 in plan view. The crushing elements 6 and the hooks 3 are arranged on the rotors 1 and the stator 4, axially one behind the other, the hooks 3 of the rotors 1 arranged parallel to one another and the crushing elements 6 of the stator being offset relative to one another so that in each case a crushing element 6 comes to rest between two hooks 3, opposite one another, of the two rotors 1 parallel to one another. The lateral distance between the crushing elements 6 and the hooks 3 or the gap between the hooks 3 and the crushing element 6 can be adjusted by centring the stator 4 axially relative to the stator axis 5.

FIGS. 3a and 3b show an example of an adjusting mechanism for displacing the position of the stator. FIG. 3a shows the stator in a deeper position “lower” in relation to the rotor. By tightening the screw 11, the stator axis 5 is displaced in the direction of the rotor axis and comes to rest in the “upper”, higher position shown in FIG. 3b.

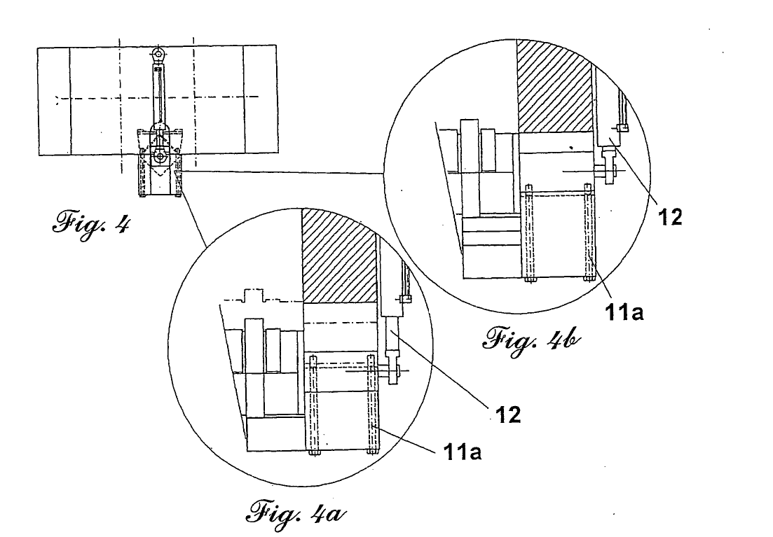

FIGS. 4, 4a and 4b show an example of a hydraulic adjusting mechanism for displacing the position of the stator. The position of the stator 4 is fixed by means of screws 11a in the crossbeams 8. For displacing the “lower”, deeper position of the stator 4 in FIG. 4a, the screws 11a are loosened and the stator 4 is raised by means of a hydraulically driven piston 12 to the “higher” position shown in FIG. 4b, with the result that the distance between the stator 4 and the rotor 1 is reduced. Thereafter, the stator 4 is once again fixed in the new position by means of the screws 11a. The hydraulic adjustment can be effected both manually and with automatic control.

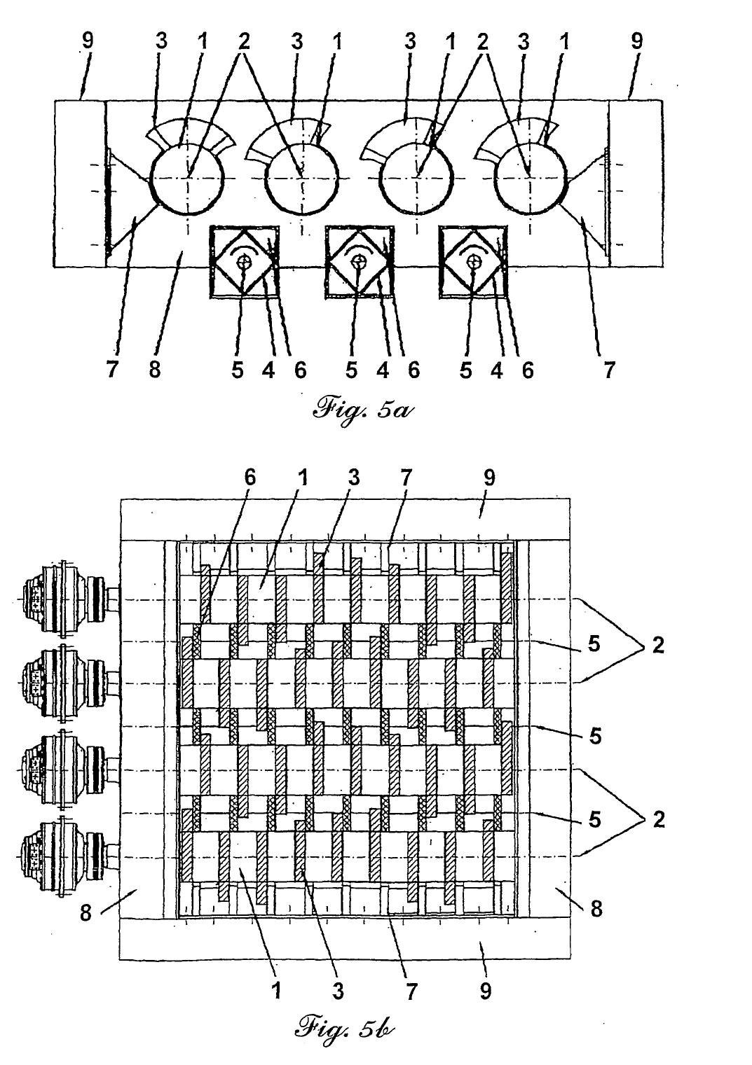

FIG. 5a shows a cross-section and FIG. 5b a plan view of a crushing device according to the invention, comprising four rotors 1 and three stators 4. The frame of the crushing device is formed from the crossbeams 8 and the longitudinal beams 9. The stators 4 and the rotors 1 are fastened to the crossbeams 8. In addition, stators 7 fixed in their position can be arranged directly on the longitudinal beams 9, and/or stators 7 displaceable in their position can be arranged on the crossbeams 8.

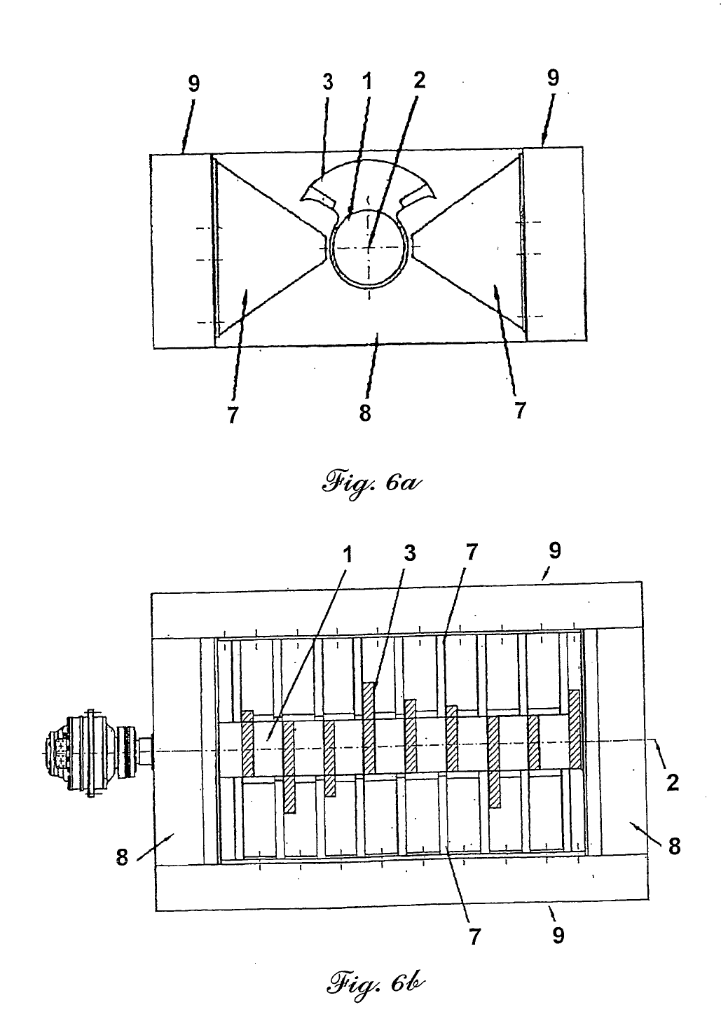

FIG. 6a shows a cross-section and FIG. 6b a plan view of a crushing device according to the invention, comprising one rotor 1 and two stators 7 arranged laterally on the longitudinal beams 9 of the frame, at least one stator 7 being displaceable relative to the rotor axis 2, in particular along the longitudinal beam 9.

1. Crushing device for crushing a material, comprising at least one rotor (1) which is rotatable about a rotor axis (2) and on whose circumference a plurality of hooks (3) are mounted along the rotor axis (2) a certain distance apart for contacting and entraining the material in a direction of material flow, and at least one stator (4, 7) to which a plurality of crushing elements (6) engaging the hooks (3) are fastened—in particular in the direction of the rotor axis—which stator (4, 7) can be offset in the direction of the rotor axis (2), characterized in that
at least one hook (3) whose plane of rotation is located in an area substantially outside the centre, based on the distance between two crushing elements (6), rotates between in each case two crushing elements (6), and
the crushing elements (6) each having at least one lateral edge (10a, 10b), which can be oriented substantially transversely to the direction of material flow, for crushing the material to be crushed which is entrained by the hooks (3),
the crushing being effected in each case substantially by that lateral edge (10a, 10b) of the crushing element (6) which can be oriented transversely to the direction of material flow, and substantially by a single hook lateral edge and possibly a hook front edge of a hook (3).

2. Crushing device according to claim 1, characterized in that
the crushing device has at least two rotors (1) parallel to one another,
a stator (4) is positioned between every two rotors (1) and
the hooks (3) are arranged opposite one another, axially offset on the rotors (1) parallel to one another, and the rotor axes (2) are a distance apart, such that the hooks (3) of the rotors arranged adjacent to one another rotate past one another at a distance such that the crushing takes place substantially between the hooks (3) and the crushing elements (6).

3. Crushing device according to claim 1 or 2, characterized in that the stator (4) is rotatable about a stator axis (5).

4. Crushing device according to claim 3, characterized in that the crushing elements (6) are in each case in the form of plates and in each case have at least three lateral edges (10a, 10b), preferably four lateral edges (10a, 10b) having a substantially orthogonal cross-section, in each case another one of the at least three lateral edges (10a, 10b) being oriented transversely to the direction of the material flow and thus participating in the crushing, depending on an angle of rotation of the stator (4) about the stator axis (5).

5. Crushing device according to any of claims 1 to 4, characterized in that the stator (4) can be hydraulically fixed and in particular the hydraulic fixing is released on reaching a predetermined compressive load, and optionally is fed in on falling below this predetermined compressive load.

6. Crushing device according to any of claims 1 to 5, characterized in that the stator (4) is displaceable axially and/or transversely to the stator axis (5).

7. Crushing device according to any of claims 1 to 6, characterized in that the crushing device is surrounded by a frame (8, 9) and the stator is arranged between the frame (8) and a hook (3) or between the frame (9) and a rotor (1).

8. Crushing device according to any of claims 1 to 7, characterized in that the rotor (1) is adjustable—optionally hydraulically.

9. Crushing device according to any of claims 1 to 8, characterized in that the hooks (3) and/or the crushing element (6) on the stator (4, 7) are replaceable and/or are at least partly covered by a protective element.
